(19) United States
(12) Patent Application Publication
(10) Pub. No.: US 2013/0044492 A1
(43) Pub. Date: Feb. 21, 2013

(54) LED LAMP

(71) Applicant: TSUTOMU TOTANI, AICHI (JP)

(72) Inventor: TSUTOMU TOTANI, AICHI (JP)

(73) Assignee: BEAT-SONIC CO., LTD., NISSHIN (JP)

(21) Appl. No.: 13/450,589

(22) Filed: Apr. 19, 2012

(30) Foreign Application Priority Data
Aug. 18, 2011 (JP) P2011-178710
Mar. 23, 2012 (JP) U2012-001597

(51) Int. Cl. F21V 29/00

(52) U.S. Cl. 362/294

(57) ABSTRACT

An LED lamp includes a heat dissipator, a socket mounted on one end of the heat dissipator, a module substrate on which an LED chip is mounted and which is fixed to a surface of the other end of the heat dissipator, a lighting circuit supplying electric power to the LED chip and mounted in the heat dissipator and electrically connected to the socket, a locking portion locking an open end of a glove on the other end surface of the heat dissipator, and a diffusing member which circumferentially diffuses light emitted by the LED chip and is fixed to the other end surface of the heat dissipator, the diffusing member being disposed so as to be opposed to the LED chip. The glove is detachably locked to the other end surface of the heat dissipator by the locking portion when the diffusing member is covered with the glove.

### CROSS-REFERENCE TO RELATED APPLICATIONS

This application is based upon and claims the benefit of priority from the prior Japanese Patent Application No. 2011-178710 filed on Aug. 18, 2011 and No. 2011-234852 filed on Oct. 26, 2011 and the prior Japanese application for utility model registration No. 2012-001597 filed on Mar. 23, 2012, the entire contents of these of which are incorporated herein by reference.

### BACKGROUND

1. Technical Field

The present disclosure relates to an LED lamp incorporating an LED chip serving as a light source.

2. Related Art

Demand for LED lamps or LED light bulbs has recently been increasing as substitute for incandescent lamps having higher electrical power consumption. The LED lamps have far less power consumption. One type of LED lamp includes a metal heat dissipator made of a metal, such as aluminum, having high heat conductivity, a socket mounted on one end of the heat dissipator, a glove comprising a light-transmissive glass or plastic material having a semi-spherical top and attached to the other end of the heat dissipator, a module substrate on which an LED chip is mounted and a lighting circuit supplying electrical power to the LED chip. The module substrate and the lighting circuit are mounted on the heat dissipator, and the LED chip is covered by the glove. The lighting circuit and the socket are electrically connected to each other. This type of LED lamp is disclosed by Japanese Patent Application Publication Nos. JP-A-2011-70972, JP-A-2011-82132, JP-A-2011-90828 and JP-A-2011-91033.

Light emitted by a filament serving as a light source for an incandescent lamp is diffused around thereby to evenly illuminate the surrounding area. On the other hand, light emitted by the LED chip used as a light source for an LED lamp has a high directionality and accordingly has a characteristic of illuminating a frontward narrow region by intense light.

Furthermore, the temperature of the filament of the incandescent lamp sometimes rises up to 2,000° C. during turn-on. As a result, the surface of the glove covering the filament is heated thereby to have a high temperature such that touch or contact to the glove surface would result in burn injury.

On the other hand, the LED chip serving as the light source for the LED lamp has an exceedingly lower calorific value during turn-on as compared with the filament. Accordingly, even the temperature of the heat dissipator rises to about several dozen degrees at the highest during turn-on. The glove has such a characteristic that the temperature thereof is so low that the glove can be touched during turn-on as compared with the incandescent lamp.

### SUMMARY

Therefore, an object of the disclosure is to provide an LED lamp which can provide new use applications by making use of high directivity and low heat dissipation of the LED chip serving as the light source thereof.

The present disclosure provides an LED lamp comprising a heat dissipator; a socket mounted on one of two ends of the heat dissipator; a module substrate on which an LED chip is mounted, the module substrate being fixed to a surface of the other end of the heat dissipator; a lighting circuit supplying electric power to the LED chip and mounted in the heat dissipator, the lighting circuit being electrically connected to the socket; a locking portion locking an open end of a glove on the other end surface of the heat dissipator; and a diffusing member which circumferentially diffuses light emitted by the LED chip and is fixed to the other end surface of the heat dissipator, the diffusing member being disposed so as to be opposed to the LED chip, wherein the glove is detachably locked to the other end surface of the heat dissipator by the locking portion when the diffusing member is covered with the glove.

Since the high directivity of light emitted by the LED is eased by the diffusing member, the light emitted by the LED can evenly illuminate the surrounding are as light emitted by the incandescent lamp. The locking portion is provided on the other end surface of the heat dissipator to which the LED chip and the diffusing member are fixed. Since the glove is detachably locked to the other end surface of the heat dissipator by the locking portion, the glove can easily be mounted on the heat dissipator.

This renders it possible for a user to use a self-produced glove as well as a ready-made glove, so that the user can make an LED lamp designed according to user's favor or preference, whereupon the usage of the LED lamp can be expanded.

Furthermore, since the glove is not heated too high as the incandescent lamp is, there is no possibility of occurrence of burn injury even when it is touched by hand. Consequently, the glove can easily be replaced.

In one embodiment, the locking portion includes a ring groove which is formed in the other end surface of the heat dissipator so as to surround the diffusing member, and the glove is locked to the other end surface of the heat dissipator by fitting the open end of the glove into the ring groove.

When the open end of glove is fitted into the ring groove, the glove can be locked to the other end surface of the heat dissipator. Furthermore, since the ring groove with a simple structure is formed as the locking portion, the usage of the LED lamp can be enlarged.

In another embodiment, the locking portion includes a ring-shaped convex strip provided on the other end surface of the heat dissipator so as to surround the diffusing member, and the glove is locked to the other end surface of the heat dissipator by covering the ring-shaped convex strip with the open end of the glove.

Since the ring-shaped convex strip is covered with the open end of the glove, the glove can be locked to the other end of the heat dissipator.

In further another embodiment, the locking portion includes a ring-shaped convex strip provided on the other end surface of the heat dissipator so as to surround the diffusing member, and the glove is locked to the other end surface of the heat dissipator by abutting an outer periphery of the open end of the glove against the ring groove.

The glove can be locked to the other end of the heat dissipator when the outer periphery of the open end of the glove is abutted against the ring-shaped convex strip. In the above-described third and fourth embodiments, since the ring-shaped convex strip with a simple structure is formed as the locking portion, the usage of the LED lamp can be enlarged at low costs.

### BRIEF DESCRIPTION OF THE DRAWINGS

In the accompanying drawings:

FIG. 1 is a sectional view of an LED lamp according to a first embodiment;

FIG. 2 is a perspective view of the LED lamp;

FIG. 3 is a front view of the LED lamp to which the glove is attached;

FIG. 4 is a perspective view of the LED lamp according to a second embodiment;

FIG. 5 is a perspective view of the LED lamp according to a third embodiment;

FIG. 6 is a perspective view of the LED lamp according to a fourth embodiment; and

FIG. 7 is a perspective view of the LED lamp according to a fifth embodiment.

### DETAILED DESCRIPTION

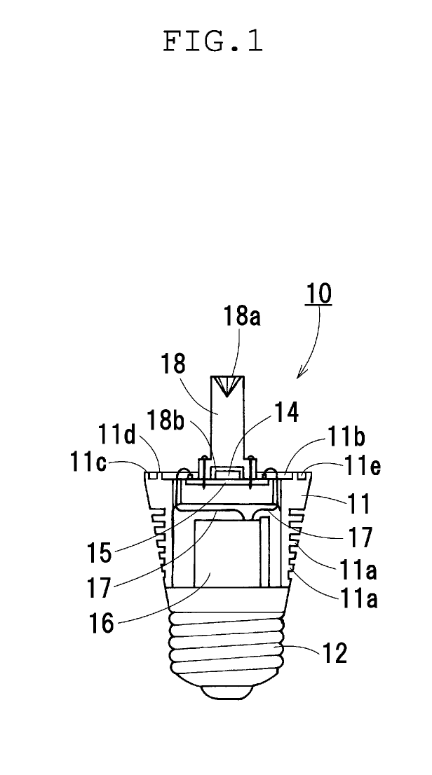

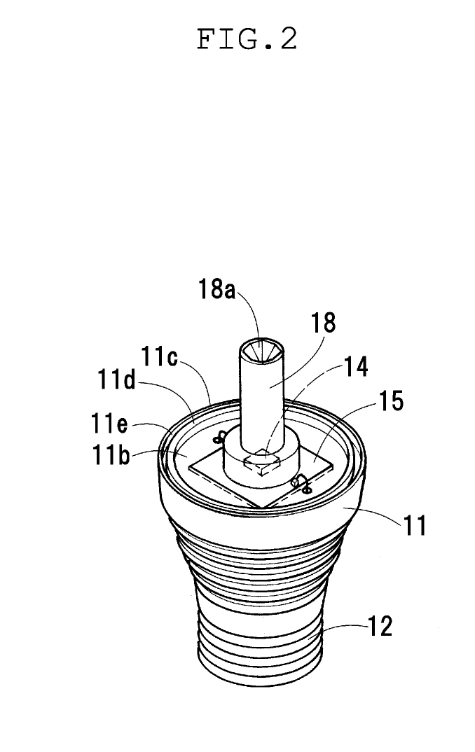

Several embodiments will be described with reference to the accompanying drawings. Referring to FIGS. 1 and 2, an LED lamp 10 according to a first embodiment is shown. The LED lamp 10 includes a heat dissipator 11 made of a metal, such as aluminum, having a high heat conductivity and a high heat dissipation performance and a socket mounted on a lower end of the heat dissipator 11 and having a shape and dimensions according to the International Standard.

The heat dissipator 11 is formed into an appearance of an inverted truncated cone and has an outer periphery formed with a number of fins 11a which increase a surface area thereby to improve a heat dissipation performance. The heat dissipator 11 has an upper end surface 11b to which a module substrate 15 is fixed. An LED chip 14 is mounted on the module substrate 15. A lighting circuit 16 is provided in the heat dissipator 11 to supply electric power to the LED chip 14. The module substrate 15 is connected by a lead wire 17 to the lighting circuit 16. The lighting circuit 16 is connected by another lead wire (not shown) to the socket 12.

The module substrate 15 fixed to the upper end surface 11b of the heat dissipator 11 has a columnar diffusing member 18 which is fixed thereto so as to stand therefrom. The diffusing member 18 has a distal end formed with a reflection portion 18a which includes a plurality of reflecting surfaces and is formed into an inverted pyramid shape. The diffusing member 18 has a proximal end formed with recess 18b and is mounted on the module substrate 15 in such a manner that the LED chip 14 is covered with the recess 18b. The LED chip 14 disposed opposite the recess 18b is configured to emit light that is incident from the recess 18b into the diffusing member 18 to be reflected on a reflecting surface of the reflection portion 18a, whereupon the light is circumferentially dissipated.

The upper end surface 11b of the heat dissipator 11 has two ring-shaped convex strips 11c and 11d having larger and smaller diameters respectively. The strips 11c and 11d are disposed concentrically about the diffusing member 18 so as to surround the diffusing member 18. A ring groove 11e is defined by both strips 11c and 11d.

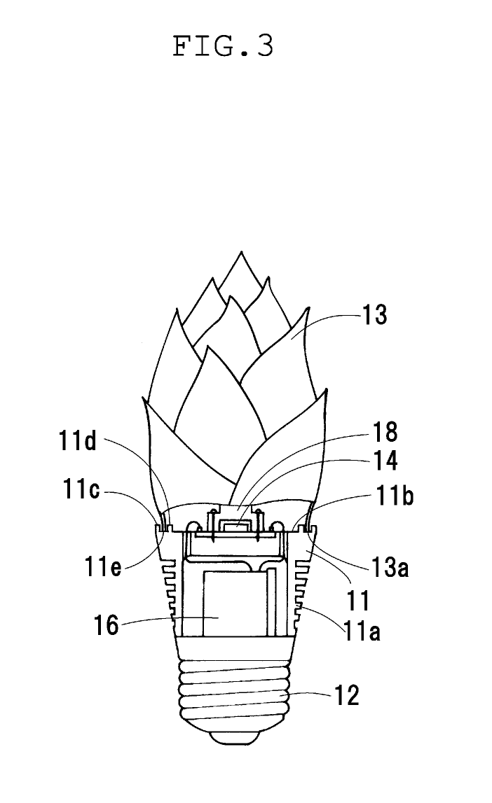

A glove 13 made of glass is attached to the upper end surface of the heat dissipator 11 when the LED lamp 10 constructed as described above is used, as shown in FIG. 3. The glove 13 has an open end 13a having substantially the same diameter as the ring groove 11e. The glove 13 is detachably attached to the upper end surface 11b of the heat dissipator 11 so that the open end 13a is fitted into the ring groove 11e.

When the LED chip 14 is lighted on, light emitted by the LED chip 14 is diffused by the diffusing member 18, so that the periphery of the LED lamp 10 can evenly be illuminated in substantially the same manner as incandescent lamps.

According to the LED lamp 10 according to the first embodiment, the ring groove 11e is provided in the upper end surface 11b of the heat dissipator 11. The open end 13a is fitted into the ring groove 11e such that the glove 13 can detachably be attached to the upper end surface 11b of the heat dissipator 11. Accordingly, the glove 13 can be prevented from dropping out of the heat dissipator 11 even when the heat dissipator 11 is inclined. The glove 13 is not heated too high as an incandescent lamp is when the LED chip 14 is lighted. Accordingly, there is no possibility of occurrence of burn injury even when the glove 13 is touched by hand. Consequently, the glove 13 can easily be replaced by hand. This renders it possible for a user to use a self-produced glove as well as a ready-made glove 13, so that the user can make an LED lamp 10 designed according to user's favor or preference, whereupon the usage of the LED lamp 10 can be expanded.

When a groove width of the ring groove 11e is set so that clearances are defined between the open end 13a and the strips 11c and 11d respectively, the glove 13 can be attached to the heat dissipator without making the glove 13 with a high dimensional accuracy. Consequently, the self-produced glove can easily be attached to the heat dissipator 11.

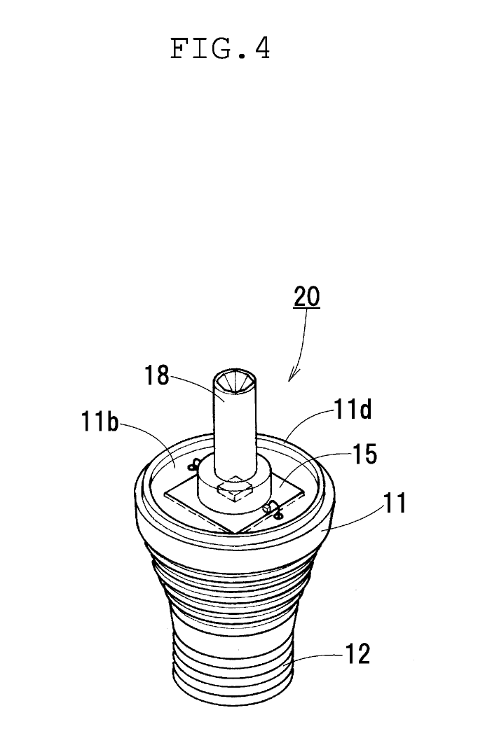

FIG. 4 illustrates a second embodiment. Although the ring groove 11e is defined by the two ring-shaped strips 11c and 11d in the LED lamp 10 of the first embodiment, the LED lamp 20 of the second embodiment is provided with only the smaller-diameter ring-shaped convex strip 11b with the larger-diameter ring-shaped convex strip 11c being eliminated. Thus, the smaller-diameter strip 11b is provided on the upper surface of the heat dissipator 11 in the second embodiment. The other construction of the LED lamp 20 is the same as that of the first embodiment and accordingly, identical or similar parts in the second embodiment are labeled by the same reference symbols as those in the first embodiment. The description of these parts will be eliminated.

In the LED lamp 20 of the second embodiment, the glove (not shown) is placed on the upper end surface of the heat dissipator 11 so that the smaller-diameter ring-shaped convex strip 11d is covered with the open end 13a of the glove.

According to the LED lamp 20 of the second embodiment, an inner periphery of the open end 13a of the glove is locked to the ring-shaped convex strip 11d. Accordingly, the glove can be prevented from dropping out of the heat dissipator 11 even when the heat dissipator 11 is inclined.

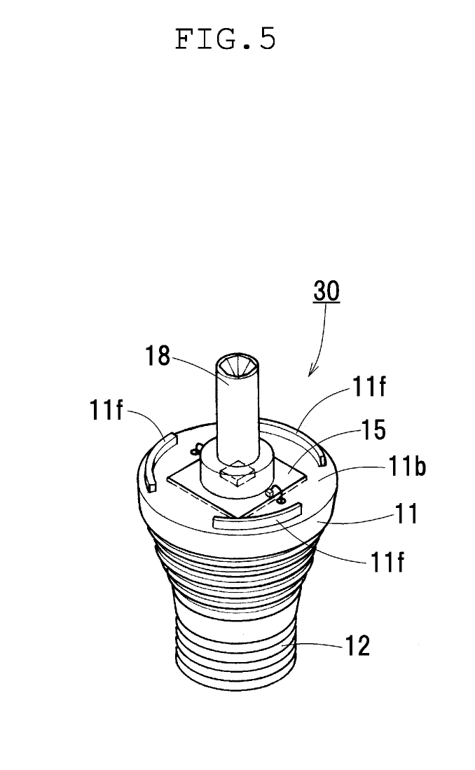

FIG. 5 illustrates a third embodiment. Three arc-shaped strips 11f are provided on the upper end surface 11b of the heat dissipator 11 in the LED lamp 30 of the third embodiment although the ring-shaped convex strip 11d with a smaller diameter is provided on the upper surface 11b of the heat dissipator 11 in the second embodiment. The other construction of the LED lamp 30 is the same as that of the LED lamp 20 of the second embodiment and accordingly, identical or similar parts in the third embodiment are labeled by the same reference symbols as those in the second embodiment. The description of these parts will be eliminated.

In the LED lamp 30 of the third embodiment, the glove (not shown) is placed on the upper end surface 11b of the heat dissipator 11 so that the arc-shaped strips 11f are covered with the open end 13a of the glove.

According to the LED lamp 30 of the third embodiment, an inner periphery of the open end 13a of the glove is locked to the arc-shaped strips 11f. Accordingly, the glove can be prevented from dropping out of the heat dissipator 11 even when the heat dissipator 11 is inclined.

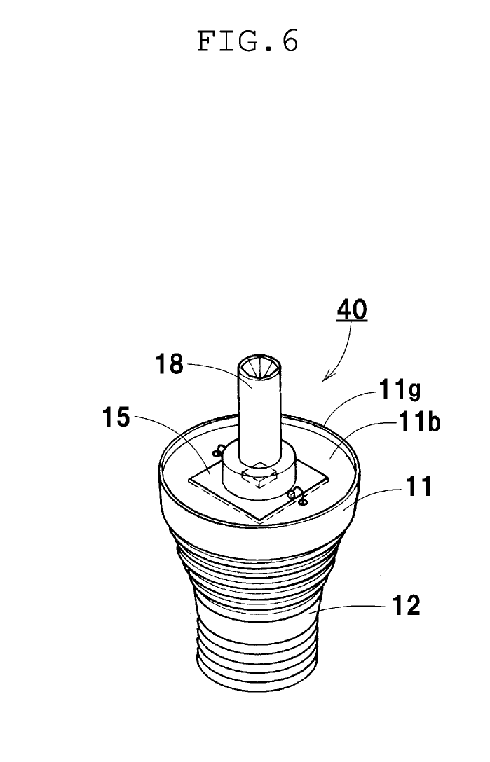

FIG. 6 illustrates a fourth embodiment. A single ring-shaped convex strip 11g is provided along the upper surface 11b of the heat dissipator 11 thereby to form an outer wall of the upper surface 11b in the LED lamp 40 of the fourth embodiment. The other construction of the LED lamp 40 is the same as that of the LED lamp 10 of the first embodiment and accordingly, identical or similar parts in the fourth embodiment are labeled by the same reference symbols as those in the first embodiment. The description of these parts will be eliminated.

In the LED lamp 40 of the fourth embodiment, the glove 13 is placed on the upper surface 11b of the heat dissipator 11 so that the outer periphery of the open end of the glove 13 abuts on the ring-shaped convex strip 11g. The outer periphery of the open end of the glove 13 thus placed abuts on the ring-shaped convex strip 11g to be locked to the upper surface 11b of the heat dissipator 11.

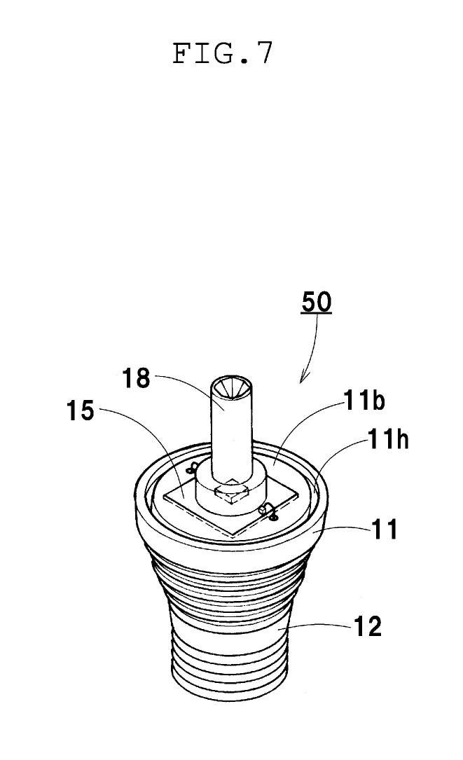

FIG. 7 illustrates a fifth embodiment. Although the ring groove 11e is defined by the two ring-shaped convex strips 11c and 11d in the first embodiment, a ring-shaped groove 11h is engraved in the upper surface 11b of the heat dissipator 11 in the fifth embodiment.

In the LED lamp 50 of the fifth embodiment, the open end of the glove 13 is fitted into the ring groove 11h such that the glove 13 can be locked to the upper surface 11b of the heat dissipator 11, in the same manner as in the LED lamp 10 of the first embodiment.

According to the LED lamp 50 of the fifth embodiment, since the convex strip is not provided on the upper surface 11b of the heat dissipator 11, there is no possibility that the convex strip is lost.

In the LED lamps 10, 20, 30, 40 and 50 of the first to fifth embodiments, the glove 13 is placed on the upper end surface 11b of the heat dissipator, and the glove 13 is locked to the ring groove 11e, the ring-shaped convex strips 11d and 11g and the arc-shaped strip 11f. However, when the glove 13 is not replaced, the open end of the glove 13 may be adhered to the ring groove 11e, the ring-shaped convex strips 11d and 11g and the arc-shaped strip 11f thereby to be fixed to the upper end surface 11b of the heat dissipator 11.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. An LED lamp comprising:
a heat dissipator;
a socket mounted on one of two ends of the heat dissipator;
a module substrate on which an LED chip is mounted, the module substrate being fixed to a surface of the other end of the heat dissipator;
a lighting circuit supplying electric power to the LED chip and mounted in the heat dissipator, the lighting circuit being electrically connected to the socket;
a locking portion locking an open end of a glove on the other end surface of the heat dissipator; and
a diffusing member which circumferentially diffuses light emitted by the LED chip and is fixed to the other end surface of the heat dissipator, the diffusing member being disposed so as to be opposed to the LED chip,
wherein the glove is detachably locked to the other end surface of the heat dissipator by the locking portion when the diffusing member is covered with the glove.

2. The LED lamp according to claim 1, wherein the locking portion includes a ring groove which is formed in the other end surface of the heat dissipator so as to surround the diffusing member, and the glove is locked to the other end surface of the heat dissipator by fitting the open end of the glove into the ring groove.

3. The LED lamp according to claim 1, wherein the locking portion includes a ring-shaped convex strip provided on the other end surface of the heat dissipator so as to surround the diffusing member, and the glove is locked to the other end surface of the heat dissipator by covering the ring-shaped convex strip with the open end of the glove.

4. The LED lamp according to claim 1, wherein the locking portion includes a ring-shaped convex strip provided on the other end surface of the heat dissipator so as to surround the diffusing member, and the glove is locked to the other end surface of the heat dissipator by abutting an outer periphery of the open end of the glove against the ring groove.
